(19) United States
(12) Patent Application Publication
(10) Pub. No.: US 2006/0141348 A1
(43) Pub. Date: Jun. 29, 2006

(54) Battery pack cooling mechanism

(76) Inventors: Hong W. Wong, Portland, OR (US); Wah Yiu Kwong, Beaverton, OR (US); Daryl J. Nelson, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/025,410

(22) Filed: Dec. 29, 2004

(51) Int. Cl. H01M 10/50; H01M 10/46

(52) U.S. Cl. 429/120; 429/7; 429/50

(57) ABSTRACT

According to one embodiment, a system is disclosed. The system includes a chassis and a battery pack mounted within the chassis. The battery pack includes one or more battery cells and cooling components to enable thermal energy generated by the one or more battery cells to be conducted and dissipated from the battery pack.

### FIELD OF THE INVENTION

The present invention relates to computer systems; more particularly, the present invention relates to dissipating heat generated while providing power to a computer system.

### BACKGROUND

Mobile computer systems, such as notebook computers, include one or more battery packs to provide power to the system whenever a permanent power source is not available. However, the high battery operational ambient temperature environment found in most notebook computers is the major contributor to the premature failure of the battery pack.

Generally, the heat sources within the notebook may originate from the battery itself which generates heat during charging and discharging. This becomes more apparent as the battery ages, with its internal impedance increases as it ages. Moreover, thermal generation will continue to become more of a concern as overall system power continues to rise as a result of increasing subsystem and component performance for the CPU, chipset, peripherals, voltage regulators, etc.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates a top view of one embodiment of a computer system motherboard;

FIG. 3 illustrates a side view of one embodiment of a battery pack;

FIG. 4 illustrates a side view of another embodiment of a battery pack; and

FIG. 5 illustrates one embodiment of cooling fins.

### DETAILED DESCRIPTION

A battery pack cooling mechanism is described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

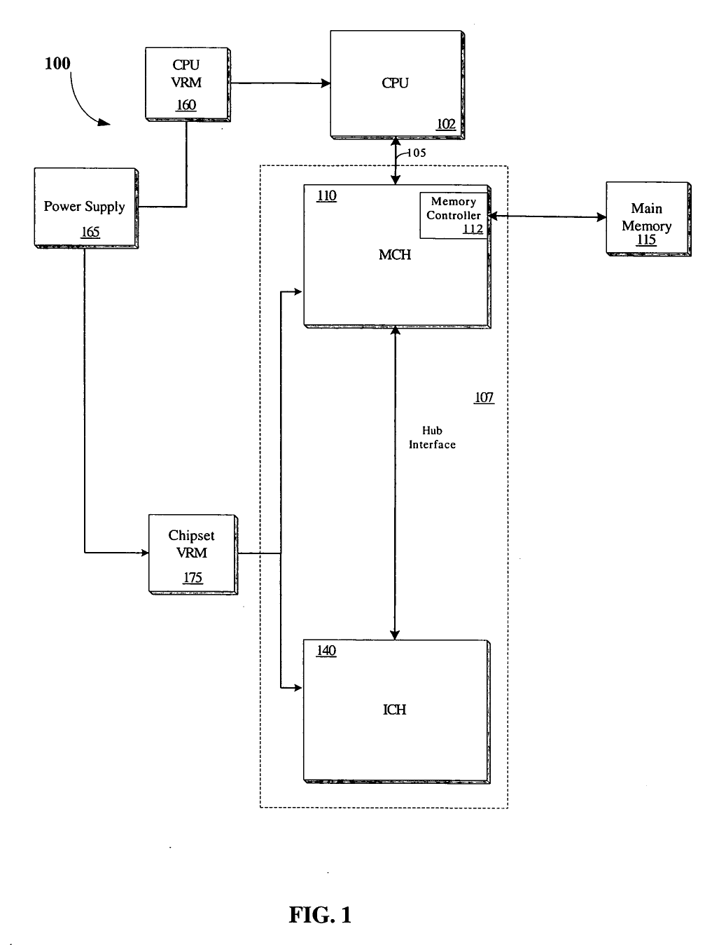

FIG. 1 is a block diagram of one embodiment of a computer system 100. According to one embodiment, computer system is a mobile computer system (e.g., a laptop, or notebook computer). Computer system 100 includes a central processing unit (CPU) 102 coupled to bus 105. In one embodiment, CPU 102 is a processor in the Pentium® family of processors including Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

MCH 110 is coupled to an input/output control hub (ICH) 140 via a hub interface. ICH 140 provides an interface to input/output (I/O) devices within computer system 100. In addition, computer system 100 includes a power supply 165 and a multitude of voltage regulators that are used to provide power to various components within computer system 100. CPU voltage regulator module (VRM) 160 provides voltage to CPU 102. VRM 175 supplies voltage for both MCH 110 and ICH 140 within chipset 107.

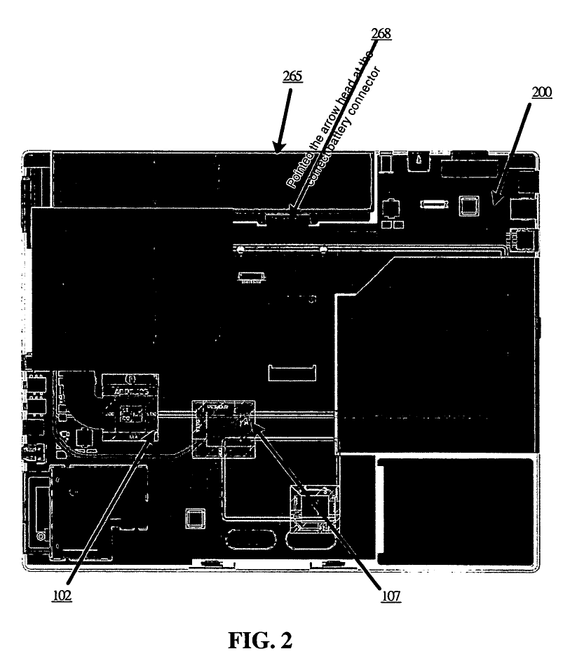

FIG. 2 illustrates a top view of one embodiment of computer system 100 in a motherboard 200 layout for a mobile computer system. Motherboard 200 is a printed circuit board (PCB) that includes the basic circuitry and integrated circuit (IC) components of computer system 100 mounted thereon. For instance, motherboard 200 includes CPU 102 and chipset 107.

In addition, motherboard 200 includes a battery pack 265 and a battery connector 268. Battery pack 265 represents the power supply 165 that provides power to the components of motherboard 200. Connector 268 serves as an interface between battery pack 265 and motherboard 200 where the battery pack 265 power is provided to motherboard 200.

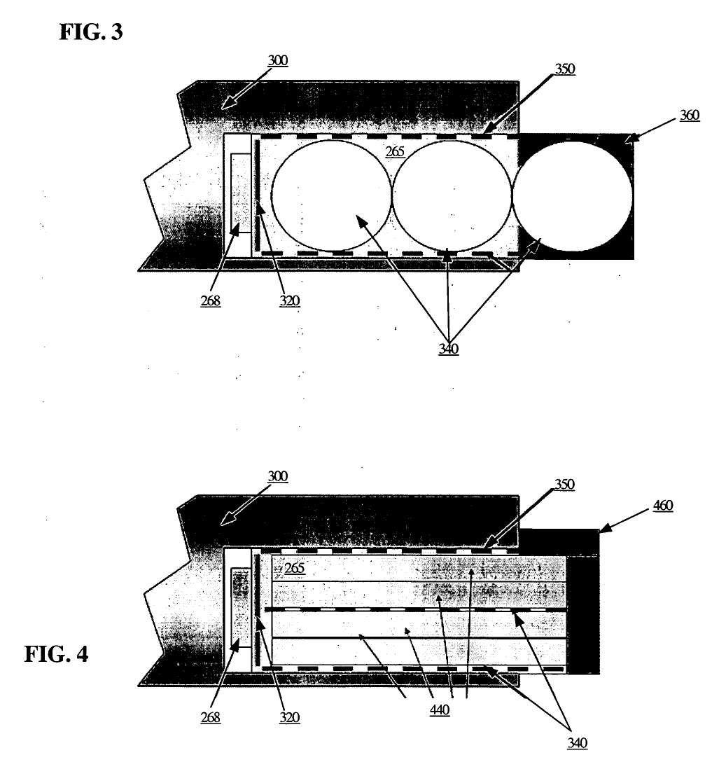

FIG. 3 illustrates a side view of one embodiment of a battery pack 265 mounted within a chassis 300. Also, shown within chassis 300 are connector 268 and circuit 320. Circuit 320 includes electrical circuitry implemented to charge batteries and/or circuitry to control the operation of the battery pack 265. According to one embodiment, battery pack 265 includes components to enable thermal energy generated by batteries within battery pack 265, as well as thermal energy generated from within chassis 300, to be conducted from and dissipated through the back of battery pack 265.

Battery pack 265 includes cylindrical battery cells 340, thermal plates 350 and covering piece 360. Note that other battery cell geometries may also be incorporated, such as a prismatic battery. In this embodiment, battery cells 340 are cylindrical battery cells that provide power to computer system 100. Thermal plates 350 include a thermal conductive material which is integrated on the battery pack 265 housing. The thermal conductive material may include copper, graphite fiber, aluminum, heat pipes, etc. In one embodiment, thermal plates 350 are mounted in parallel with battery cells 340. However in other embodiments, thermal plates 350 may be mounted perpendicular to battery cells 340.

Thermal plates 350 are coupled to cover piece 360, which is located at the rear of the battery pack. In one embodiment, cover piece 360 extends out from chassis 300 to provide additional space for a battery pack 340. In a further embodiment, cover piece 360 includes passive heat convection and radiating fins to enable thermal energy to dissipate via natural convection or radiation cooling. Moreover, for the above-described the cylindrical battery pack 265 design, the corner areas of cover piece 360 are utilized for the passive fin design. In other embodiments, the system exhaust may be used to increase heat transfer from these extended surfaces.

In one embodiment, cover piece 360 also includes vent holes to assist the venting of the heat from the heat radiating fins. Further, heat spreading and dissipation may be augmented with heat pipes, system venting, and forced air cooling. In a further embodiment, the above-described mechanism is also be extended to dissipate thermal energy generated by circuit 320, which is typically overlooked in the thermal design of chassis 300 because of the transitory nature of circuit 320.

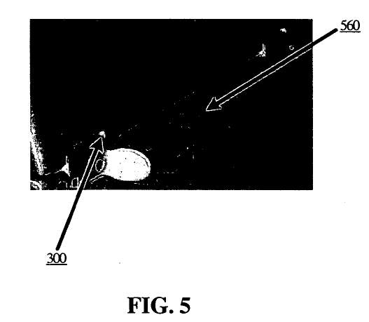

FIG. 4 illustrates a side view of another embodiment of battery pack 265 mounted within chassis 300. In this embodiment, battery pack 265 implements prismatic, or other rectangular, cells 440. Further, a cover piece 460 is included at the rear of battery pack 265 that has vertical fins. FIG. 5 illustrates one embodiment of cooling fins 560 mounted on chassis 310. As shown in FIG. 5, the addition of cooling fins 560 has little or no impact on the overall dimensions of computer system 100.

The thermal design of above-described battery pack lowers the battery pack temperature, and reduces the cooling penalty on the remainder of a notebook system (e.g., charging system), thereby extending the life span of the battery and potentially other components in the system.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A system comprising:
a chassis; and
a battery pack, mounted within the chassis, having:
one or more battery cells; and
cooling components to enable thermal energy generated by the one or more battery cells to be conducted and dissipated from the battery pack.

2. The system of claim 1 wherein the cooling components comprise:
one or more thermal plates; and
a cover piece having radiating fins to dissipate the thermal energy.

3. The system of claim 2 wherein the thermal plates are in parallel with the battery cells.

4. The system of claim 2 wherein the thermal plates are perpendicular to the battery cells.

5. The system of claim 4 wherein the thermal plates are comprised of a material within the group of copper, graphite rubber and aluminum.

6. The system of claim 2 wherein the cover piece includes vent holes to vent the thermal energy from the radiating fins.

7. The system of claim 2 wherein the radiating fins dissipate the thermal energy via natural convection.

8. The system of claim 2 wherein the radiating fins dissipate the thermal energy via radiation cooling.

9. The system of claim 3 further comprising charge circuitry coupled to the battery pack to recharge the one or more battery cells.

10. The system of claim 9 wherein the cooling components dissipate thermal energy generated by the charge circuitry.

11. The system of claim 3 further comprising:
a connector coupled to the battery pack; and
a printed circuit board coupled to the connector.

12. A method comprising cooling thermal energy generated at battery cells within a battery pack by dissipating the thermal energy via cooling components within the battery pack.

13. The method of claim 12 further comprising radiator fins dissipating the thermal energy.

14. The method of claim 13 further comprising venting the thermal energy from the radiator fins.

15. The method of claim 12 further comprising the cooling components dissipating thermal energy generated by recharge circuitry coupled to the battery pack.

16. A battery pack comprising:
one or more battery cells; and
a cover piece having radiating fins to conduct and dissipate thermal energy generated by the one or more battery cells.

17. The battery pack of claim 16 further comprising one or more thermal plates.

18. The battery pack of claim 17 wherein the thermal plates are in parallel with the battery cells.

19. The battery pack of claim 17 wherein the thermal plates are perpendicular to the battery cells.

20. The battery pack of claim 16 wherein the cover piece includes vent holes to vent the thermal energy from the radiating fins.
